(19) United States
(12) Patent Application Publication
(10) Pub. No.: US 2021/0123213 A1
(43) Pub. Date: Apr. 29, 2021

(54) HYDRAULIC DRIVE DEVICE FOR OPERATING MACHINE

(71) Applicants: KABUSHIKI KAISHA KOBE SEIKO SHO (Kobe Steel, Ltd.), Kobe-shi (JP); KOBELCO CONSTRUCTION MACHINERY CO., LTD., Hiroshima-shi (JP)

(72) Inventors: Satoshi MAEKAWA, Kobe-shi (JP); Hiroaki KAWAI, Kobe-shi (JP); Yusuke KAMIMURA, Hiroshima (JP)

(73) Assignees: KABUSHIKI KAISHA KOBE SEIKO SHO (Kobe Steel, Ltd.), Kobe-shi (JP); KOBELCO CONSTRUCTION MACHINERY CO., LTD., Hiroshima-shi (JP)

(21) Appl. No.: 17/052,980

(22) PCT Filed: Apr. 22, 2019
(86) PCT No.: PCT/JP2019/016963

§ 371 Date: Nov. 4, 2020

(30) Foreign Application Priority Data
May 14, 2018 (JP) 2018-093013

(51) Int. Cl. E02F 9/22; E02F 3/43

(52) U.S. Cl. CPC E02F 9/2235; E02F 3/437

(57) ABSTRACT

A hydraulic drive apparatus capable of automatic control with high accuracy regardless of regeneration operation includes a boom flow rate control valve, an arm flow rate control valve, a regeneration control valve, a pump control device for performing horsepower control, a posture detection device, a boom flow rate control device switchable between a normal control mode and an automatic control mode, and a regeneration control device. The boom flow rate control device adjusts the boom flow rate in the automatic control mode so that a work attachment moves along a target locus. The regeneration control device sets the regeneration control valve to a regeneration position in a low load situation and to a regeneration cut position in a high load situation, and lowers the regeneration rate in the low load situation when the boom flow rate control device is switched to the automatic control mode.

### TECHNICAL FIELD

The present invention relates to an apparatus provided to a work machine such as a hydraulic excavator including a raiseable and lowerable boom and an arm connected to the boom to hydraulically drive the boom and the arm.

### BACKGROUND ART

A general hydraulic work machine includes a machine body, a work device supported by the machine body, and a hydraulic drive apparatus that hydraulically actuates the work device. The work device operates in response to an operation applied to an operation lever by an operator to thereby perform a predetermined work motion. Specifically, the work device includes a boom supported by the machine body so as to be raiseable and lowerable, an arm connected to a distal end of the boom so as to be rotationally movable, and a working attachment connected to a distal end of the arm so as to be rotationally movable. For example, in a hydraulic excavator, the work attachment is a bucket for excavation. The hydraulic drive apparatus includes a boom cylinder and an arm cylinder which are hydraulic actuators for actuating the boom and the arm, respectively, a hydraulic pump for supplying hydraulic fluid to the boom cylinder and the arm cylinder, a control valve for controlling the supply of the hydraulic fluid, and the like.

Furthermore, in recent years, in order to reduce the burden on the operator, development has been advanced on a hydraulic drive apparatus having an automatic control function of controlling the driving of the boom and the arm of the work device so as to move the work attachment along a preset target locus only by a simple operation performed by the operator.

For example, Patent Document 1 discloses a hydraulic drive apparatus provided in a hydraulic excavator including a boom, an arm, and a bucket, the apparatus having an automatic control function of moving the boom upward in response to the movement of the arm in a retraction direction so as to make a cutting edge of the bucket moved in the retraction direction of the arm along a horizontal plane, that is, so that horizontal leveling work is performed.

Besides, as means for efficiently increasing the speed of the motion of the boom in the retraction direction, it is known to provide a regeneration fluid path. The regeneration fluid path is a fluid path for returning a part of the hydraulic fluid discharged from a rod-side chamber of the arm cylinder directly to a head-side chamber of the arm cylinder bypassing the tank during the retraction motion of the arm. For example, Patent Document 2 discloses performing a regeneration operation of supplying hydraulic fluid discharged from the rod-side chamber of the arm cylinder to the head-side chamber when the excavation load is small to render the pressure in the rod-side chamber of the arm cylinder low and performing a regeneration cut control of returning hydraulic fluid discharged from the rod-side chamber directly to the tank to secure a high excavation force when the excavation load is large to render the pressure of the rod-side chamber high.

However, applying the regeneration control as described in Patent Document 2 to the hydraulic drive apparatus having an automatic control function as described in Patent Document 1 involves a problem of difficulty in controlling the movement locus of the work attachment with high accuracy because the regeneration cut causes a large speed fluctuation. Specifically, when the regeneration cut control is executed because of increase in the pressure in the rod-side chamber of the arm cylinder due to a sharp increase in an excavation load from the state in which the regeneration operation is being performed, there occurs a response delay from the sharp increase in the excavation load until a regeneration valve is actually switched to a regeneration cut position. The regeneration cut position is a position for letting the hydraulic fluid discharged from the rod-side chamber not flow through the regeneration flow path but return to the tank through a meter-out flow path. In the time period of the response delay, the discharge of hydraulic fluid from the rod-side chamber is restricted to prevent hydraulic fluid from sufficiently escaping, thus causing a significant increase in the pressure in the rod-side chamber. Moreover, in the case of the hydraulic pump for supplying the hydraulic fluid to the arm cylinder being a variable displacement type one, the capacity of the hydraulic pump is generally subjected to a horsepower control, i.e., a control of adjusting the capacity of the hydraulic pump so as to keep the horsepower of the hydraulic pump within an allowable horsepower that is set for the engine which is the driving source thereof; this causes the pressure in the head-side chamber to be rapidly restricted in response to the sharp increase in the capacity. The flow rate of the hydraulic fluid supplied to the arm cylinder is thereby sharply reduced to significantly reduce the speed of the arm cylinder. This hinders the automatic control, i.e., the control of synchronizing the speed of the arm cylinder and the speed of the boom cylinder so that the work attachment moves along the target locus, from being performed with high accuracy.

### CITATION LIST

### Patent Literature

Patent Document 1: Japanese Unexamined Patent Application Publication No. 9-328774

Patent Document 2: Japanese Unexamined Patent Application Publication No. 10-267007

### SUMMARY OF INVENTION

It is an object of the present invention to provide a hydraulic drive apparatus provided in a work machine equipped with a work device including a boom, an arm, and a work attachment to hydraulically actuate the work device, the hydraulic drive apparatus being capable of performing both an automatic control of synchronizing respective movements of the boom and the arm so as to make the work attachment moved along a predetermined target locus and a regeneration operation of regenerating return fluid from an arm cylinder for actuating the arm, and further capable of performing the automatic control with high accuracy regardless of the execution of the regeneration operation.

Provided is a hydraulic drive apparatus provided in a work machine equipped with a machine body and a work device, the work device including a boom supported by the machine body so as to be raiseable and lowerable, an arm connected to a distal end of the boom rotationally movably, and a work attachment attached to a distal end of the arm, to hydraulically drive the boom and the arm, the hydraulic drive apparatus including: a hydraulic fluid supply device including at least one variable displacement type hydraulic pump that is driven by a drive source to thereby discharge hydraulic fluid; a boom cylinder that is expanded and contracted by supply of the hydraulic fluid from the hydraulic fluid supply device to raise and lower the boom; an arm cylinder that is expanded and contracted by supply of hydraulic fluid from the hydraulic fluid supply device to rotationally actuate the arm, the arm cylinder having a head-side chamber and a rod-side chamber opposite to the head-side chamber, the arm cylinder connected to the arm so as to be expanded by supply of the hydraulic fluid to the head-side chamber to actuate the arm in a retraction direction and so as to be contracted by supply of the hydraulic fluid to the rod-side chamber to actuate the arm in a push direction; a pilot-operated boom flow rate control valve interposed between the hydraulic fluid supply device and the boom cylinder and being capable of being opened and closed so as to change a boom flow rate, which is a flow rate of hydraulic fluid supplied from the hydraulic fluid supply device to the boom cylinder; a pilot-operated arm flow rate control valve interposed between the hydraulic fluid supply device and the arm cylinder and being capable of being opened and closed so as to change an arm flow rate, which is a flow rate of hydraulic fluid supplied from the hydraulic fluid supply device to the arm cylinder; a regeneration control valve having a regeneration position for forming a regeneration flow path that allows a discharge hydraulic fluid that is discharged from the rod-side chamber to return to the head-side chamber when the arm cylinder is expanded and a meter-out flow path that allows the discharge hydraulic fluid to return to a tank, and a regeneration cut position for blocking the regeneration flow path and maximizing an opening area of the meter-out flow path, the regeneration control valve being capable of being opened and closed so as to change a regeneration rate, which is a ratio of a regeneration flow rate to a total return flow rate that is a total sum of the regeneration flow rate and a meter-out flow rate, the regeneration flow rate and the meter-out flow rate being respective flow rates of the hydraulic fluids flowing through the regeneration flow path and the meter-out flow path, respectively; a boom operation device to which a boom operation for moving the boom is applied, an arm operation device to which an arm operation for moving the arm is applied; a pump control device that executes a horsepower control of adjusting a capacity of the at least one hydraulic pump so as to keep a total horsepower of the at least one hydraulic pump included in the hydraulic fluid supply device within an allowable horsepower that is set for the drive source; a posture detection device that detects a posture of the work device for determining a position of the work attachment; a boom flow rate control device that is switchable between a normal control mode and an automatic control mode, the boom flow rate control device configured to allow, in the normal control mode, the boom flow rate control valve and the arm flow rate control valve to operate so as to change the boom flow rate and the arm flow rate in response to the boom operation and the arm operation applied to the boom operation device and the arm operation device, respectively, and configured to adjust, in the automatic control mode, the boom flow rate based on the posture detected by the posture detection device so as to make the work attachment moved along a preset target locus; and a regeneration control device configured to set the regeneration control valve to the regeneration position in a low load situation where an arm head pressure, which is a pressure of the hydraulic fluid supplied to the head-side chamber of the arm cylinder, is equal to or less than a preset allowable pressure and configured to set the regeneration control valve to the regeneration cut position in a high load situation where the arm head pressure is higher than the allowable pressure. The regeneration control device operates the regeneration control valve so as to make the regeneration rate in the low load situation lower when the boom flow rate control device is switched to the automatic control mode than that when the boom flow rate control device is switched to the normal control mode.

### BRIEF DESCRIPTION OF DRAWINGS

FIG. 1 is a side view showing a hydraulic excavator which is a hydraulic work machine according to an embodiment of the present invention.

FIG. 2 is a diagram showing a hydraulic circuit and a controller, the hydraulic circuit including components of a hydraulic drive apparatus installed on the hydraulic excavator.

FIG. 3 is a symbol showing details of the regeneration position and the regeneration cut position of a regeneration control valve in the hydraulic drive apparatus.

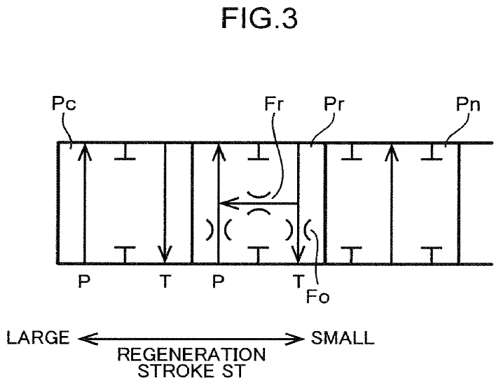

FIG. 4 is a graph showing the relationship between the stroke of the regeneration control valve and respective throttle openings of a regeneration flow path and a meter-out flow path.

FIG. 5 is a block diagram showing respective main components of a plurality of control devices included in the hydraulic drive apparatus.

FIG. 6 is a flowchart showing an arithmetic control operation executed by a pump control device in the hydraulic drive apparatus.

FIG. 7 is a graph showing a horsepower curve used for a horsepower control performed by the pump control device.

FIG. 8 is a flowchart showing an arithmetic control operation executed by a boom flow rate control device in the hydraulic drive apparatus.

FIG. 9 is a graph showing the relationship between a target boom cylinder speed and a target boom pilot pressure calculated by the boom flow rate control device in the automatic control mode.

FIG. 10 is a flowchart showing an arithmetic control operation executed by a merge control device in the hydraulic drive apparatus.

FIG. 11 is a flowchart showing an arithmetic control operation executed by a regeneration control device in the hydraulic drive apparatus.

### DESCRIPTION OF EMBODIMENTS

There will be described a preferred embodiment of the invention with reference to the drawings.

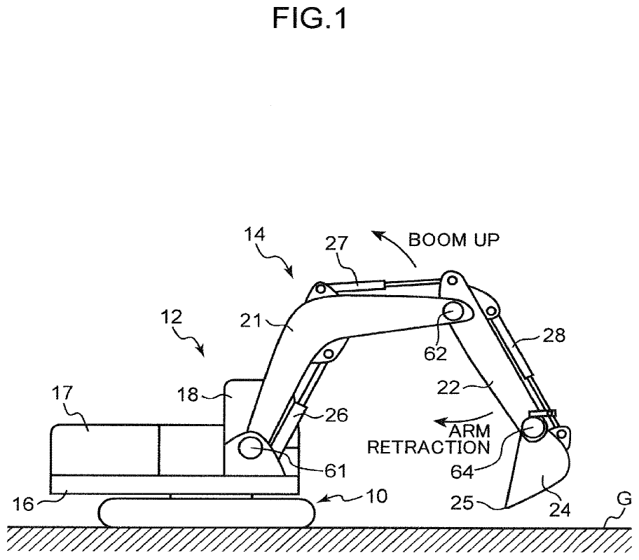

FIG. 1 shows a hydraulic excavator according to the embodiment. The work machine to which the present invention is applied is not limited to the hydraulic excavator. The present invention can be widely applied to a working machine equipped with a machine body, a boom which is supported by the machine body so as to be raiseable and lowerable, an aim connected to a distal end of the boom so as to be rotationally movable, and a working attachment attached to a distal end of the arm.

The hydraulic excavator includes a lower traveling body 10 capable of traveling on the ground G, an upper turning body 12 mounted on the lower traveling body 10, a work device 14 mounted on the upper turning body 12, and a hydraulic drive apparatus that hydraulically drives the work device 14.

The lower traveling body 10 and the upper turning body 12 constitute a machine body that supports the work device 14. The upper turning body 12 includes a turning frame 16 and a plurality of elements mounted thereon. The plurality of elements include an engine room 17 that houses the engine and a cab 18 that is an operation room.

The work device 14 is capable of performing operations for excavation work or other necessary work, including a boom 21, an arm 22, and a bucket 24. The boom 21 has a proximal end supported on the front end of the turning frame 16 so as to be raiseable and lowerable, that is, movable rotationally about a horizontal axis, and a distal end opposite to the distal end. The arm 22 has a proximal end attached to the distal end of the boom 21 so as to be movable rotationally about a horizontal axis, and a distal end opposite to the proximal end. The bucket 24, which corresponds to a tip attachment, is attached to the distal end of the arm 22 rotationally movably.

The hydraulic drive apparatus includes a plurality of expandable hydraulic cylinders provided for the boom 21, the arm 22 and the bucket 24, respectively, namely, a pair of boom cylinders 26, an arm cylinder 27 and a bucket cylinder 28.

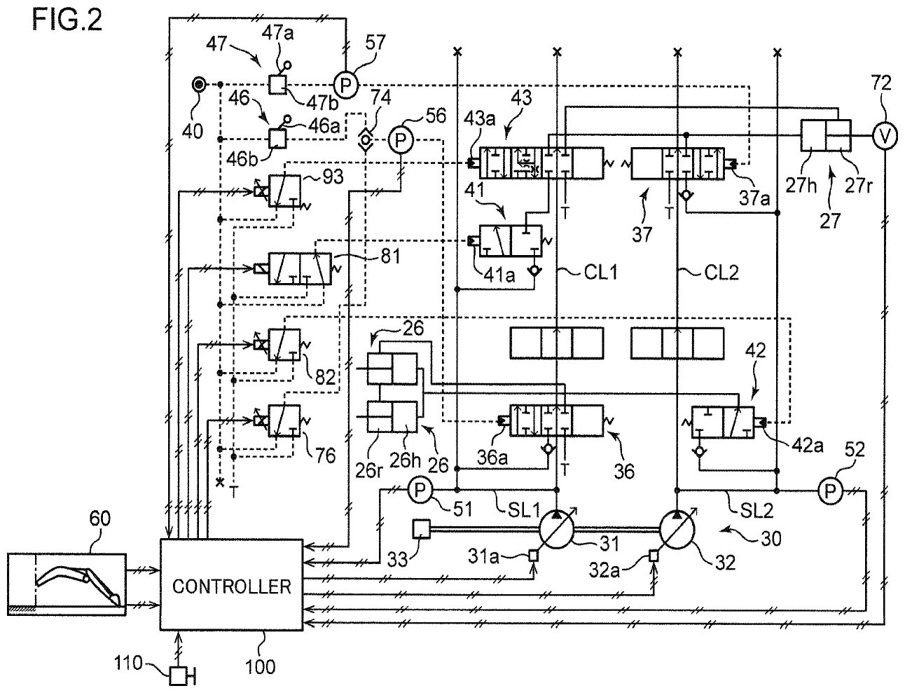

Each of the pair of boom cylinders 26 is interposed between the upper turning body 12 and the boom 21 and expanded and contracted so as to make the boom 21 perform rising and falling motions. The boom cylinder 26 has a head-side chamber 26h and a rod-side chamber 26r shown in FIG. 2, configured to be expanded by supply of hydraulic fluid to the head-side chamber 26h to actuate the boom 21 in a boom-up direction with discharge of hydraulic fluid from the rod-side chamber 26r and configured to be contracted by supply of hydraulic fluid to the rod-side chamber 26r to actuate the boom 21 in a boom-down direction with discharge of hydraulic fluid from the head-side chamber 26h. Incidentally, the boom cylinder according to the present invention may be a single hydraulic cylinder disposed at the center in the boom width direction.

The arm cylinder 27 is an arm actuator interposed between the boom 21 and the arm 22 and expanded and contracted to make the arm 22 perform a rotational motion. Specifically, the arm cylinder 27 has a head-side chamber 27h and a rod-side chamber 27r shown in FIG. 2, configured to be expanded by supply of hydraulic fluid to the head-side chamber 27h to actuate the arm 22 in an arm retraction direction (the direction in which the tip end of the arm 22 approaches the boom 21) with discharge of hydraulic fluid from the rod-side chamber 27r and configured to be contracted by supply of hydraulic fluid to the rod-side chamber 27r to actuate the arm 22 in an arm push direction (the direction in which the tip end of the arm 22 moves away from the boom 21) with discharge of hydraulic fluid from the head-side chamber 27h.

The bucket cylinder 28 is interposed between the arm 22 and the bucket 24 and configured to be expanded and contracted so as to make the bucket 24 perform a rotational motion. Specifically, the bucket cylinder 28 is expanded to thereby actuate the bucket 24 rotationally in a scooping direction (the direction in which the tip 25 of the bucket 24 approaches the arm 22) and contracted to thereby actuate the bucket 24 in an opening direction (the tip 25 of the bucket 24 goes away from the arm 22).

The bucket cylinder 28 is not an essential component of the present invention. In the case of attaching a work attachment other than a bucket to the arm, there may be equipped a work actuator that is other than a bucket cylinder and corresponds to the work attachment. Besides, the work actuator may be driven by an apparatus other than the hydraulic drive apparatus according to the present invention. In summary, the hydraulic drive apparatus according to the present invention only has to include elements for hydraulically driving the boom and the arm.

FIG. 2 shows a hydraulic circuit installed on the hydraulic excavator and a controller 100 electrically connected thereto. FIG. 2 shows, more specifically, elements for hydraulically driving the boom 21 and the arm 22 in the hydraulic circuit. The controller 100 consists of, for example, a microcomputer, controlling the operation of each element included in the hydraulic circuit. To the controller 100 is connected a mode selector switch 110. The mode selector switch 110, which is disposed in the operation room, inputs to the controller 100 a mode command signal corresponding to an operation that is applied to the mode selector switch 110 for switching the control mode of the controller 100 between a normal control mode and an automatic control mode which are described in detail later.

The hydraulic circuit includes, in addition to the boom cylinder 26 and the arm cylinder 27, a hydraulic fluid supply device 30, a boom flow rate control valve 36, an arm flow rate control valve 37, a boom operation device 46, an arm operation device 47, a first merge selector valve 41, a second merge selector valve 42, and a regeneration control valve 43.

The hydraulic fluid supply device 30 includes a first hydraulic pump 31 and a second hydraulic pump 32. The first and second hydraulic pumps 31 and 32 are connected to an engine 33, which is a driving source, to be driven by the power output by the engine 33 to discharge hydraulic fluid. Each of the first and second hydraulic pumps 31 and 32 is a variable displacement type pump. Specifically, the first and second hydraulic pumps 31 and 32 have respective regulators 31a, 32a. Respective capacities of the first and second hydraulic pumps 31, 32 are operated by respective inputs of the pump capacity commands to the regulators 31a, 32a from the controller 100.

The boom flow rate control valve 36 is interposed between the first hydraulic pump 31 included in the hydraulic fluid supply device 30 and the pair of boom cylinders 26, configured to be opened and closed to change a boom flow rate which is the flow rate of hydraulic fluid supplied from the first hydraulic pump 31 to the boom cylinder 26. Specifically, the boom flow rate control valve 36 is formed of a pilot operated three-position direction selector valve having a boom-up pilot port 36a and a not-graphically-shown boom-down pilot port, disposed in a middle of a first center bypass line CL1 connected to the first hydraulic pump 31.

The boom flow rate control valve 36 is switched to a neutral position with no pilot pressure input to either of the boom-up and boom-down pilot ports, opening the first center bypass line CL1 and blocking the communication between the first hydraulic pump 31 and the boom cylinder 26. The boom cylinder 26 is thereby kept stopped.

By input of a boom-up pilot pressure to the boom-up pilot port 36a, the boom flow rate control valve 36 is shifted from the neutral position to a boom-up position by a stroke corresponding to the magnitude of the boom-up pilot pressure, thus being opened to allow hydraulic fluid to be supplied from the first hydraulic pump 31 to the head-side chambers 26h of the pair of boom cylinders 26 through a first supply line SL1 branched from the first center bypass line CL1 at the flow rate corresponding to the stroke (boom flow rate), and to allow hydraulic fluid from the rod-side chambers 26r of the pair of boom cylinders 26 to return to the tank. The boom cylinder 26 is thereby driven in the boom-up direction at the speed corresponding to the boom-up pilot pressure.

Conversely, by input of a boom-down pilot pressure to the boom-down pilot port, the boom flow rate control valve 36 is shifted from the neutral position to a boom-down position by a stroke corresponding to the magnitude of the boom-down pilot pressure, thus being opened to allow hydraulic fluid to be supplied from the first hydraulic pump 31 to each of the rod-side chambers 26r of the pair of boom cylinders 26 through the first supply line SL1 at the flow rate (boom flow rate) corresponding to the stroke, and to allow hydraulic fluid from each of the head-side chambers 26h of the pair of boom cylinders 26 to return to the tank. The boom cylinder 26 is thereby driven in the boom-down direction at the speed corresponding to the boom-down pilot pressure.

The arm flow rate control valve 37 is interposed between the second hydraulic pump 32 included in the hydraulic fluid supply device 30 and the arm cylinder 27, configured to be opened and closed to change an arm flow rate which is the flow rate of hydraulic fluid supplied from the second hydraulic pump 32 to the arm cylinder 27. Specifically, the arm flow rate control valve 37 is formed of a pilot operated three-position direction selector valve having an arm retraction pilot port 37a and a not-graphically-shown arm push pilot port, being disposed in a middle of a second center bypass line CL2 connected to the second hydraulic pump 32.

The arm flow rate control valve 37 is switched to a neutral position with no pilot pressure input to either of the arm retract and arm push pilot ports, opening the second center bypass line CL2 and blocking the communication between the second hydraulic pump 32 and the arm cylinder 27. The arm cylinder 27 is thereby kept stopped.

By input of an arm retraction pilot pressure to the arm retraction pilot port 37a, the arm flow rate control valve 37 is shifted from the neutral position to an arm retraction position by a stroke corresponding to the magnitude of the arm retraction pilot pressure, thus being opened to allow hydraulic fluid to be supplied from the second hydraulic pump 32 to the head-side chamber 27h of the arm cylinder 27 through a second supply line SL2 branching from the second center bypass line CL2 at the flow rate corresponding to the stroke (arm flow rate) and to allow hydraulic fluid from the rod-side chamber 27r to return to the tank. The arm cylinder 27 is thereby driven in the arm retraction direction at the speed corresponding to the arm retraction pilot pressure.

Conversely, by input of an arm push pilot pressure to the arm push pilot port, the arm flow rate control valve 37 is shifted from the neutral position to an arm push position by a stroke corresponding to the magnitude of the arm push pilot pressure, thus being opened to allow hydraulic fluid to be supplied from the second hydraulic pump 32 to the rod-side chamber 27r of the arm cylinder 27 through the second supply line SL2 at the flow rate corresponding to the stroke (arm flow rate) and to allow hydraulic fluid from the head-side chamber 27h of the arm cylinder 27 to return to the tank. The arm cylinder 27 is thereby driven in the arm push direction at the speed corresponding to the arm push pilot pressure.

The boom operation device 46, to which a boom operation for moving the boom is applied, allows the boom-up pilot pressure or boom-down pilot pressure corresponding to the boom operation to be input to the boom flow rate control valve 36. Specifically, the boom operation device 46 includes a boom lever 46a that allows a rotational operation corresponding to the boom operation to be applied to the boom lever 46a in the operation room, and a boom pilot valve 46b coupled to the boom lever 46a.

The boom pilot valve 46b is interposed between a pilot hydraulic pressure source 40 and both the pilot ports of the boom flow rate control valve 36 (only boom-up pilot port 36a is typically shown in FIG. 2). The boom pilot valve 46b is opened in conjunction with the boom operation applied to the boom lever 46a so as to allow a boom-up pilot pressure or a boom-down pilot pressure having a magnitude corresponding to the magnitude of the boom operation to be input from the pilot hydraulic pressure source 40 to the pilot port that is one of both the pilot ports and corresponds to the direction of the boom operation. For example, by the application of the boom operation to the boom lever 46a in a direction corresponding to the boom-up motion, the boom pilot valve 46b is opened so as to allow the boom-up pilot pressure corresponding to the magnitude of the boom operation to be supplied to the boom-up pilot port 36a.

The arm operation device 47, to which an aim operation for moving the arm 22 is applied, allows an arm retraction pilot pressure or an arm push pilot pressure corresponding to the arm operation to be input to the arm flow rate control valve 37. Specifically, the arm operation device 47 includes an arm lever 47a that allows a rotational operation corresponding to the arm operation to be applied to the arm lever 47a in the operation room, and an arm pilot valve 47b coupled to the arm lever 47a.

The arm pilot valve 47b is interposed between the pilot hydraulic pressure source 40 and both the pilot ports of the arm flow rate control valve 37 (only the arm retraction pilot port 37a is typically shown in FIG. 2). The arm pilot valve 47b is opened in conjunction with the arm operation applied to the arm lever 47a, so as to allow an arm retraction pilot pressure or an arm push pilot pressure having a magnitude corresponding to the magnitude of the arm operation to be input from the pilot hydraulic pressure source 40 to the pilot port that is one of both the pilot ports and corresponds to the direction of the arm operation. For example, by the application of the arm operation in the direction corresponding to the arm retraction motion to the arm lever 47a, the arm pilot valve 47b is opened so as to allow the arm retraction pilot pressure corresponding to the magnitude of the arm operation to be supplied to the arm retraction pilot port 37a.

The first merge selector valve 41 is interposed between the first supply line SL1 and the arm cylinder 27 and configured to be opened so as to allow a part of the hydraulic fluid discharged from the first hydraulic pump 31 to be merged with the hydraulic fluid discharged from the second hydraulic pump 32 to be supplied to the head-side chamber 27h of the arm cylinder 27. Specifically, the first merge selector valve 41 is formed of a pilot operated two-position selector valve having a first merge pilot port 41a. The first merge selector valve 41 is kept in a merge check position (right position in FIG. 2), with no pilot pressure supplied to the first merge pilot port 41a, to block the communication between the first supply line SL1 and the arm cylinder 27 to check the merge of hydraulic fluid; on the other hand, by supply of the first merge pilot pressure to the first merge pilot port 41a, the first merge selector valve 41 is shifted to a merge allowance position (left position in FIG. 2) to allow hydraulic fluid to be supplied from the first supply line SL1 to the head-side chamber 27h of the arm cylinder 27 (i.e., to allow hydraulic fluid from the first hydraulic pump 31 to be merged with the hydraulic fluid from the second hydraulic pump 32).

The first merge selector valve 41 according to this embodiment is an on-off selector valve capable of just being opened and closed by the presence or absence of the input of the first merge pilot pressure. The first merge selector valve according to the present invention, however, may have a flow rate adjusting function of changing the flow rate of the hydraulic fluid (the flow rate of the hydraulic fluid merged with the hydraulic fluid from the second hydraulic pump), for example, according to the magnitude of the pilot pressure that is input.

The second merge selector valve 42 is interposed between the second supply line SL2 and the pair of boom cylinders 26 and configured to be opened so as to allow a part of the hydraulic fluid discharged from the second hydraulic pump 32 to be merged with the hydraulic fluid discharged from the first hydraulic pump 31 to be supplied to the head-side chamber 26h of each of the pair of boom cylinders 26. Specifically, the second merge selector valve 42 is formed of a pilot operated two-position selector valve having a second merge pilot port 42a. The second merge selector valve 42 is kept in a merge check position (left position in FIG. 2), with no pilot pressure supplied to the second merge pilot port 42a, to block the communication between the second supply line SL2 and the boom cylinder 26 to check the merge; on the other hand, by supply of the second merge pilot pressure to the second merge pilot port 42a, the second merge selector valve 42 is shifted to a merge allowance position (right position in FTG. 2) to allow hydraulic fluid to be supplied from the second supply line SL2 to the head-side chamber 26h of the boom cylinder 26 (i.e., to allow hydraulic fluid from the second hydraulic pump 32 to be merged with the hydraulic fluid from the first hydraulic pump 31).

The second merge selector valve 42 according to this embodiment has a flow rate adjusting function of changing the flow rate of the hydraulic fluid (the flow rate of the hydraulic fluid merged with the hydraulic fluid from the first hydraulic pump 31) according to the magnitude of the second merge pilot pressure input to the second merge pilot port 42a. The second merge selector valve according to the present invention, however, may be an on-off selector valve capable of just being opened and closed by the presence or absence of the input of the pilot pressure.

The regeneration control valve 43 is provided in a middle of the first center bypass line CL1 and interposed between the first merge selector valve 41 and the arm cylinder 27. The regeneration control valve 43 is opened so as to perform a regeneration operation of returning a part of the discharge hydraulic fluid that is discharged from the rod-side chamber 27r to the head-side chamber 27h of the arm cylinder 27 during the expansion of the arm cylinder 27.

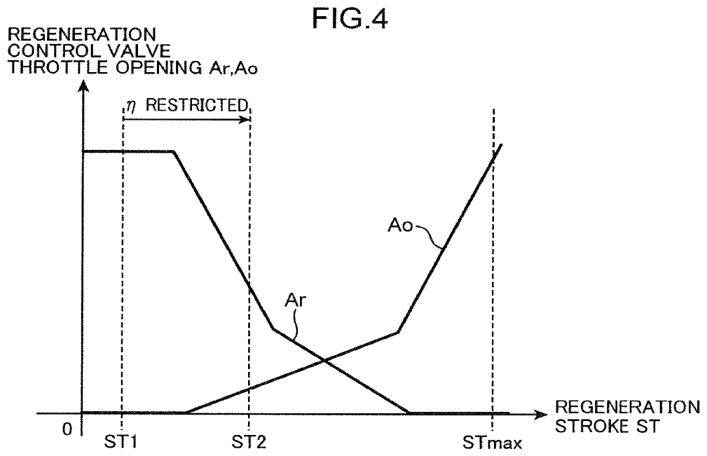

Specifically, the regeneration control valve 43 is a pilot operated selector valve having a regeneration pilot port 43a, configured to be opened in accordance with the magnitude of the pilot pressure input to the regeneration pilot port 43a. The regeneration control valve 43 has at least, as shown in FIG. 4, a neutral position Pn, a regeneration position Pr and a regeneration cut position Pc. In the neutral position Pn, the regeneration control valve 43 opens the first center bypass line CL1 and blocks the communication between the first merge selector valve 41 and the arm cylinder 27; in the regeneration position Pr, the regeneration control valve 43 forms a regeneration flow path Fr allowing a part of the discharge hydraulic fluid from the rod-side chamber 27r of the arm cylinder 27 to return directly to the head-side chamber 27h and a meter-out flow path Fo allowing the remainder of the discharge hydraulic fluid to return to the tank; in the regeneration cut position Pc, the regeneration control valve 43 blocks the regeneration flow path Fr and maximizes the opening area of the meter-out flow path Fo.

The regeneration control valve 43 further has a characteristic of a regeneration throttle opening Ar and a meter-out throttle opening Ao that are changed in accordance with the magnitude of the regeneration pilot pressure input to the regeneration pilot port 43a. The regeneration throttle opening Ar is a throttle opening of the regeneration flow path Fr, and the meter-out throttle opening Ao is a throttle opening of the meter-out flow path Fo. The regeneration control valve 43, thus, has a function of being opened and closed so as to change a regeneration rate The regeneration rate η is the ratio of a regeneration flow rate Qr to the total return flow path Qt that is the sum of the regeneration flow rate Qr and a meter-out flow rate Qo(η=Qr/Qt=Qr/(Qr+Qo)), wherein the regeneration flow rate Qr and the meter-out flow rate Qo are respective flow rates of the hydraulic fluid flowing through the regeneration flow path Fr and the meter-out flow path Fo.

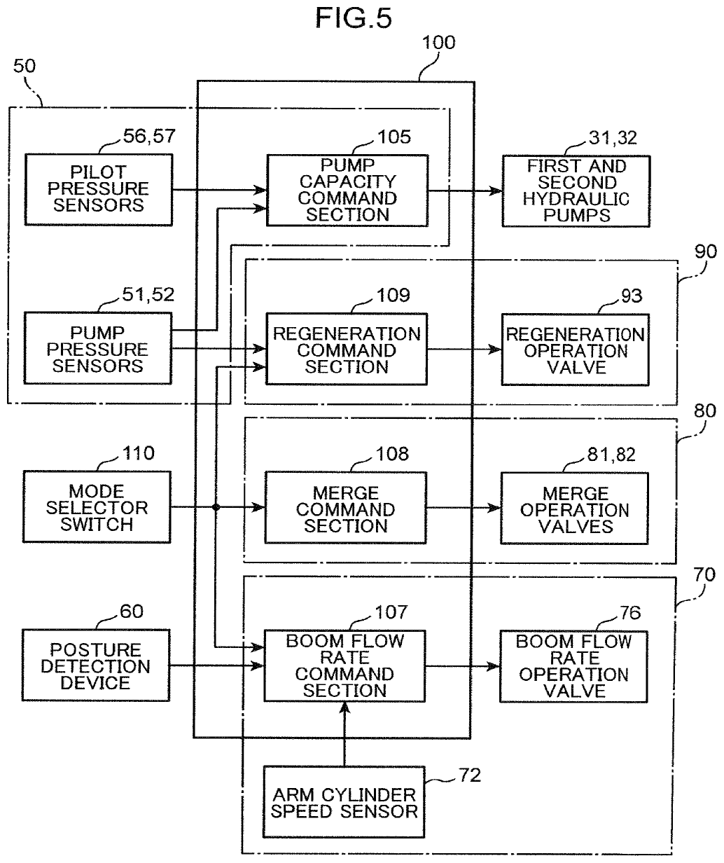

FIG. 5 shows the characteristics of the regeneration throttle opening Ar and the meter-out throttle opening Ao with respect to a regeneration stroke ST of the regeneration control valve 43. The above regeneration stroke ST means a stroke of the spool of the regeneration control valve 43 from a position where the regeneration throttle opening Ar is the maximum toward the regeneration cut position Pc. The regeneration stroke ST changes in accordance with the magnitude of the regeneration pilot pressure. As shown in FIG. 5, the regeneration throttle opening Ar is decreased with an increase in the regeneration stroke ST (i.e., with the stroke of the regeneration control valve 43 in a direction from the regeneration position Pr toward the regeneration cut position Pc). being substantially 0 (regeneration cut) when the stroke ST is the maximum stroke STmax. On the other hand, the meter-out throttle opening Ao is increased with an increase in the regeneration stroke ST, being maximized when the stroke ST is the maximum stroke STmax.

As shown in FIGS. 2 and 4, the regeneration control valve 43 forms a merge allowance fluid path in each of the regeneration position Pr and the regeneration cut position Pc. The merge allowance fluid path is a fluid path that allows the hydraulic fluid discharged from the first hydraulic pump 31 to be supplied to the head-side chamber 27h of the arm cylinder 27 through the merge allowance fluid path, that is, to be merged with the hydraulic fluid discharged from the first hydraulic pump 31. The merge allowance fluid path allows the regeneration control valve 43 to perform the regeneration operation and the merge allowance operation simultaneously while being disposed in the merge fluid path between the first merge selector valve 41 and the arm cylinder 27.

Incidentally, the regeneration control valve 43 may have, in addition to the respective positions Pn, Pr and Pc, a position for guiding hydraulic fluid from the first hydraulic pump 31 to the rod-side chamber 27r of the arm cylinder 27 and guiding the return fluid from the head-side chamber 27h of the arm cylinder 27 to the tank, contrary to the regeneration cut position Pc.

The hydraulic drive apparatus further includes, as shown in FIG. 5, a pump control device 50, a posture detection device 60, a boom flow rate control device 70, a merge control device 80 and a regeneration control device 90.

The pump control device 50 has a function of controlling a first pump capacity and a second pump capacity which are respective capacities of the first and second hydraulic pumps 31 and 32 included in the hydraulic fluid supply device 30. The pump control device 50 according to this embodiment executes simultaneously a horsepower control and a positive control with respect to the first and second pump capacities. The horsepower control is a control of adjusting (restricting) the capacities of the hydraulic pumps 31 and 32 so as to keep the total horsepower of the first and second hydraulic pumps 31 and 32 within an allowable horsepower that is set for the engine 33 as a driving source. The positive control is a control of increasing the first pump capacity with an increase in the boom pilot pressure Ppb input to the boom flow rate control valve 36 and increasing the second pump capacity with an increase in the arm pilot pressure Ppa input to the arm flow rate control valve 37.

Specifically, the pump control device 50 includes a first pump pressure sensor 51 that detects a first pump pressure P1 which is the discharge pressure of the first hydraulic pump 31, a second pump pressure sensor 52 that detects the second pump pressure P2 which is the discharge pressure of the second hydraulic pump 32, boom pilot pressure sensors 56 that detect the boom pilot pressures Ppb (FIG. 2 shows only the sensor for detecting the boom-up pilot pressure), arm pilot pressure sensors 57 for detecting the arm pilot pressure Ppa (FIG. 2 shows only the sensor for detecting the armed pilot pressure), and a pump capacity command section 105 included in the controller 100. The pump capacity command section 105 generates a pump capacity command for executing the positive control and the horsepower control based on the detection signals input from the sensors 51, 52, 56 and 57, and inputs the pump capacity command to respective regulators 31a, 32a of the first and second hydraulic pump 31, 32 to thereby execute the control of the pump capacity.

The posture detection device 60 detects the posture of the work device 14 for determining the position of the bucket 24 as the work attachment. Specifically, the posture detection device 60, as shown in FIG. 1, includes a boom angle sensor 61, an arm angle sensor 62 and a bucket angle sensor 64. The boom angle sensor 61 detects a boom angle which is an angle by which the boom 21 is raised relatively to the machine body; the arm angle sensor 62 detects an arm angle which is an angle of the rotational movement of the arm 22 relative to the boom 21; the bucket angle sensor 64 detects a bucket angle which is an angle of the rotational movement of the bucket 24 relative to the arm 22. Each of the sensors 61, 62 and 64 generates an angle detection signal and input it to the controller 100.

The boom flow rate control device 70 operates the boom flow rate control valve 36 to thereby control the boom flow rate. The boom flow rate control device 70 is switched between the normal control mode and the automatic control mode in accordance with a mode command signal input from the mode selector switch 110. In the normal control mode, the boom flow rate control device 70 allows the boom flow rate control valve 36 and the arm flow rate control valve 37 to operate so as to change the boom flow rate and the arm flow rate in response to the boom operation and the arm operation that are applied to the boom operation device 46 and the arm operation device 47, respectively. On the other hand, in the automatic control mode, the boom flow rate control device 70 determines the position of the bucket 24 as the work attachment based on the posture of the work device 14 detected by the posture detection device 60, and performs an operation of adjusting the boom flow rate in accordance with the movement of the arm 22 so as to make the bucket 24 moved along a target locus set in advance. The target locus is, for example, a horizontal locus set on the ground G or a locus along a slope or the like.

Specifically, the boom flow rate control device 70 includes an arm cylinder speed sensor 72 that detects a stroke speed of the arm cylinder 27, a boom flow rate operation valve 76 for forcibly changing the boom-up pilot pressure to be input to the boom flow rate control valve 36 in the automatic control mode, a shuttle valve 74 shown in FIG. 2, and a boom flow rate command section 107 included in the controller 100.

The boom flow rate operation valve 76 is, as shown in FIG. 2, interposed between the boom-up pilot port 36a of the boom flow rate control valve 36 and the pilot hydraulic pressure source 40 in parallel with the boom operation valve 46, and configured to reduce the pilot pressure output from the pilot hydraulic pressure source 40 to thereby generate a boom-up pilot pressure independent of the secondary pressure of the boom pilot valve 46b of the boom operation device 46. Specifically, the boom flow rate operation valve 76 according to this embodiment is formed of a solenoid proportional pressure reducing valve, configured to reduce the pressure input from the pilot hydraulic pressure source 40 in accordance with the boom flow rate command input from the boom flow rate command section 107 to thereby generate a boom-up pilot pressure having a magnitude corresponding to the boom flow rate command.

The shuttle valve 74 has a pair of input ports and an output port. The pair of input ports are connected to the boom operation device 46 and the boom flow rate operation valve 76, respectively. The output port is connected to the boom-up pilot port 36a of the boom flow rate control valve 36. The shuttle valve 74 is opened so as to allow the higher pilot pressure between the boom-up pilot pressures input from the boom operation valve 46 and the boom flow rate operation valve 76, respectively, to be input to the boom-up pilot port 36a.

The boom flow rate command section 107 generates an appropriate boom flow rate command depending on the control mode that is selected between the normal control mode and the automatic control mode by the operation applied to the mode selector switch 110 and inputs the boom flow rate command to the boom flow rate operation valve 76 to thereby operate the boom flow rate control valve 36. Specifically, the boom flow rate command section 107 performs no generation and no input of the boom flow rate command in the normal control mode, thereby keeping the secondary pressure of the boom flow rate operation valve 76 at a minimum pressure. On the other hand, in the automatic control mode, the boom flow rate command section 107 generates a boom flow rate command capable of achieving a boom flow rate for moving the bucket 24 along the target locus and inputs it to the boom flow rate operation valve 76.

The merge control device 80 executes a merge switching control. The merge switching control is a control of shifting the first merge selector valve 41 and the second merge selector valve 42 to respective merge allowance positions in accordance with the arm operation and the boom operation when the boom flow rate control device 70 is switched to the normal control mode and setting the first merge selector valve 41 and the second merge selector valve 42 to respective merge check positions regardless of the boom operation and the arm operation when the boom flow rate control device 70 is switched to the automatic control mode.

Specifically, the merge control device 80 includes a first merge operation valve 81, a second merge operation valve 82, and a merge command section 108 included in the controller 100.

The first merge operation valve 81 is interposed between the first merge pilot port 41a of the first merge selector valve 41 and the pilot hydraulic pressure source 40, being opened and closed. Specifically, the first merge operation valve 81 according to this embodiment is formed of a two-position solenoid selector valve, configured to be closed with no input of a first merge command from the merge command section 108 to block the supply of the pilot pressure from the pilot hydraulic pressure source 40 to the first merge pilot port 41a, and configured to be opened by the input of the first merge command from the merge command section 108 to allow a pilot pressure to be supplied from the pilot hydraulic pressure source 40 to the first merge pilot port 41a.

The second merge operation valve 82 is interposed between the second merge pilot port 42a of the second merge selector valve 42 and the pilot hydraulic pressure source 40, being opened and closed. Specifically, the second merge operation valve 82 according to this embodiment is formed of a solenoid proportional pressure reducing valve, configured to be closed with no input of a second merge command from the merge command section 108 to block the supply of the pilot pressure from the pilot hydraulic pressure source 40 to the second merge pilot port 42a, and configured to be opened by input of the second merge command from the merge command section 108 to generate the secondary pressure corresponding to the magnitude of the second merge command and input the secondary pressure as the pilot pressure to the second merge pilot port 42a.

The merge command section 108 performs generation and input of the first and second merge commands in accordance with the control mode of the boom flow rate control device 70. Specifically, in the case where the boom flow rate control device 70 is in the normal control mode, the merge command section 108 generates the first merge command and inputs it to the first merge operation valve 81 when the magnitude of the arm retraction operation applied to the arm operation device 47 is equal to or greater than a constant value, thereby allowing the first merge pilot pressure to be input to the first merge pilot port 41a of the first merge selector valve 41. The arm retraction operation is the arm operation for making the arm 22 perform the arm retraction motion. Similarly, the merge command section 108 generates the second merge command and inputs it to the second merge operation valve 82 when the magnitude of the arm retraction operation is equal to or more than a constant value, thereby allowing the second merge pilot pressure to be input to the second merge pilot port 42a of the second merge selector valve 42. Meanwhile, when the boom flow rate control device 70 is in the automatic control mode, the merge command section 108 stops both the generation and input of the first and second merge commands to hinder either of the first and second merge pilot pressures from being input to the first and second merge pilot ports 41a, 42a.

The regeneration control device 90 executes the control of the regeneration operation of the regeneration control valve 43. The control is executed in accordance with the arm head pressure that is the pressure of the hydraulic fluid supplied to the head-side chamber 27h of the arm cylinder 27 and the control mode of the boom flow rate control device 70.

The regeneration control device 90 according to this embodiment performs a regeneration cut control of switching the regeneration control valve 43 to the regeneration position Pr in a low load situation where a second pump pressure (discharge pressure of the second hydraulic pump 32) P2 detected by the second pump pressure sensor 52 is equal to or less than an allowable pressure P2a that is set in advance, and switching the regeneration control valve 43 to the regeneration cut position Pc in a high load situation where the second pump pressure P2 is higher than the allowable pressure P2a. The regenerative cut control prevents the meter-out flow path from being unnecessarily throttled to render the load of the arm cylinder 27 excessively large in spite that the arm head pressure is so high that regeneration of the hydraulic fluid from the rod-side chamber 27r to the head-side chamber 27h is impossible.

The regeneration control device 90 further performs a characteristic regeneration rate control. The regeneration rate control is a control of adjusting the regeneration stroke ST of the regeneration control valve 43 so as to render the regeneration rate η in the low load situation low, in the case where the boom flow rate control device 70 is switched to the automatic control mode, as compared with the case where the boom flow rate control device 70 is switched to the normal control mode.

Specifically, the regeneration control device 90 includes a regeneration operation valve 93 interposed between the pilot hydraulic pressure source 40 and the regeneration pilot port 43a of the regeneration control valve 43, and a regeneration command section 109 included in the controller 100. The regeneration operation valve 93 is formed of a solenoid proportional pressure reducing valve, configured to be opened to generate a secondary pressure corresponding to the magnitude of the regeneration rate command input from the regeneration command section 109 and to input the secondary pressure to the regeneration pilot port 43a as a regeneration pilot pressure. The regeneration command section 109 is configured to generate, in the low load situation, a regeneration rate command for obtaining the regeneration rate corresponding to the control mode of the boom flow rate control device 70 to input it to the regeneration operation valve 93 and configured to generate, in the high load situation, a regeneration rate command for switching the regeneration control valve 43 to the regeneration cut position Pc (i.e., for obtain a regeneration rate of substantially 0) to input it to the regeneration operation valve 93.

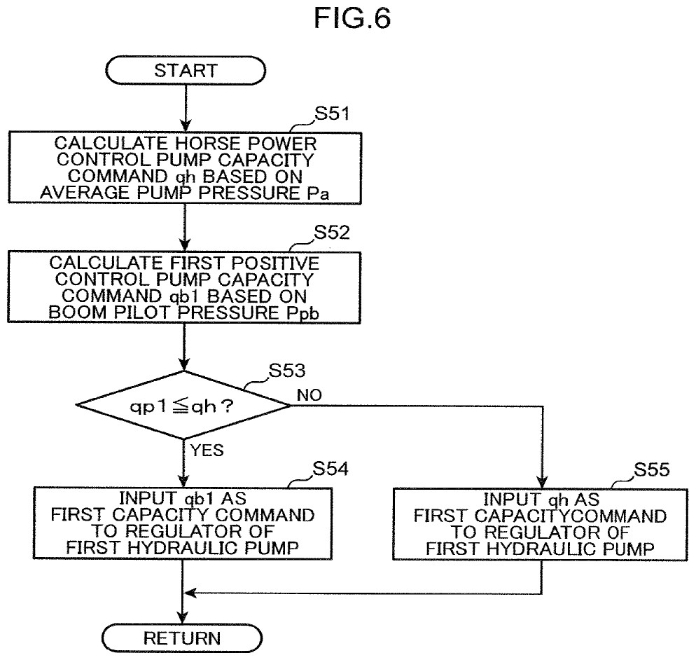

Next will be described respective arithmetic control operations performed by the control devices 50, 70, 80 and 90 and the actions of the hydraulic drive apparatus involved thereby, with reference to the flowcharts of FIGS. 6, 8 and 10.

FIG. 6 shows the arithmetic control operation for the pump capacity of the first hydraulic pump 31 typically among the arithmetic control operations performed by the pump control unit 50.

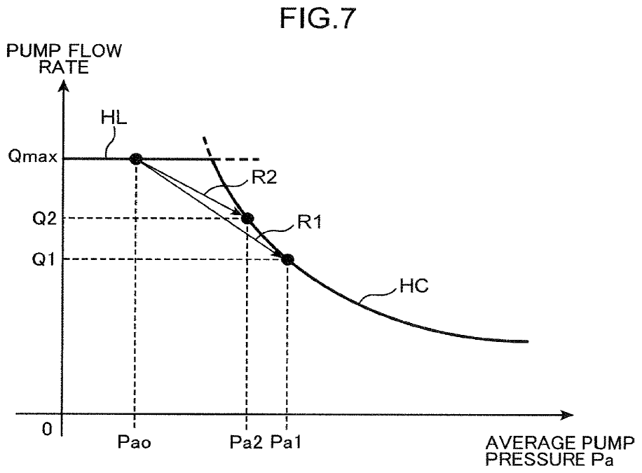

The pump capacity command section 105 of the pump control device 50 calculates a horsepower control pump capacity command qh, based on the average pump pressure Pa that is an average of the first pump pressure P 1 and the second pump pressure P2 (step S51 in FIG. 6). In this embodiment, a horsepower curve is set as shown in FIG. 7 for the engine 33 as the driving source of the first and second hydraulic pumps 31 and 32. The pump capacity command section 105 calculates the horsepower control pump capacity command qh for obtaining the pump capacity to locate the total horsepower of the first and second hydraulic pumps 31 and 32 on the horsepower curve, based on the average pump pressure Pa.

The horsepower curve according to this embodiment is constituted by a horizontal straight-line HL and a downward convex curve HC as shown in FIG. 7. The horizontal straight-line HL represents such a property as to allow the pump flow rate to be set to the maximum pump flow Qmax regardless of the average pump pressure Pa, in the area where the average pump pressure Pa is low. The curve HC respesents a property to restrict the pump flow rate than the maximum pump flow Qmax to a degree increased with an increase in the average pump pressure Pa, in the area where the average pump pressure Pa is high.

On the other hand, the pump capacity command section 105 calculates a first positive control pump capacity command qp1, based on the boom pilot pressure Ppb (step S52). The first positive control pump capacity command qp1 is calculated to increase the pump flow rate with an increase in the boom pilot pressure Ppb, that is, with an increase in the boom operation.

The pump capacity command section 105 compares the horsepower control pump capacity command qh with the first positive control pump capacity command qp1 (step S53); when the first positive control pump capacity command qp1 is equal to or less than the horsepower control pump capacity command qh or less (YES in step S53), the pump capacity command section 105 inputs the first positive control pump capacity command qp1 to the regulator 31a of the first hydraulic pump 31 as a first capacity command (step S54). On the other hand, when the first positive control pump capacity command qp1 is greater than the horsepower control pump capacity command qh (NO in step S53), the pump capacity command section 105 inputs the horsepower control pump capacity command qh to the regulator 31a of the first hydraulic pump 31 as the first capacity command (step S55).

Through the above-described arithmetic control operation, performed is a control for obtaining the pump capacity of the first hydraulic pump 31 commensurate with the boom operation with restriction of the total horsepower of the first and second hydraulic pumps 31, 32 to a horsepower under the horsepower curve shown in FIG. 7 (namely, horsepower control and positive control).

The arithmetic control operation for the pump capacity of the second hydraulic pump 32 is also performed in the same manner as described above. In the arithmetic control operation, a second positive control pump capacity command qp2 is calculated based on the arm pilot pressure Ppa, in place of the step S52. When the second positive control pump capacity command qp2 is equal to or less than the horsepower control pump capacity command qh, the second positive control pump capacity command qp2 is input to the regulator 32a of the second hydraulic pump 32 as the second capacity command. When the second positive control pump capacity command qp2 is greater than the horsepower control pump capacity command qh, the horsepower control pump capacity command qh is input to the regulator 32a of the second hydraulic pump 32 as the second capacity command. The horsepower control and the positive control are thereby performed also for the pump capacity of the second hydraulic pump 32.

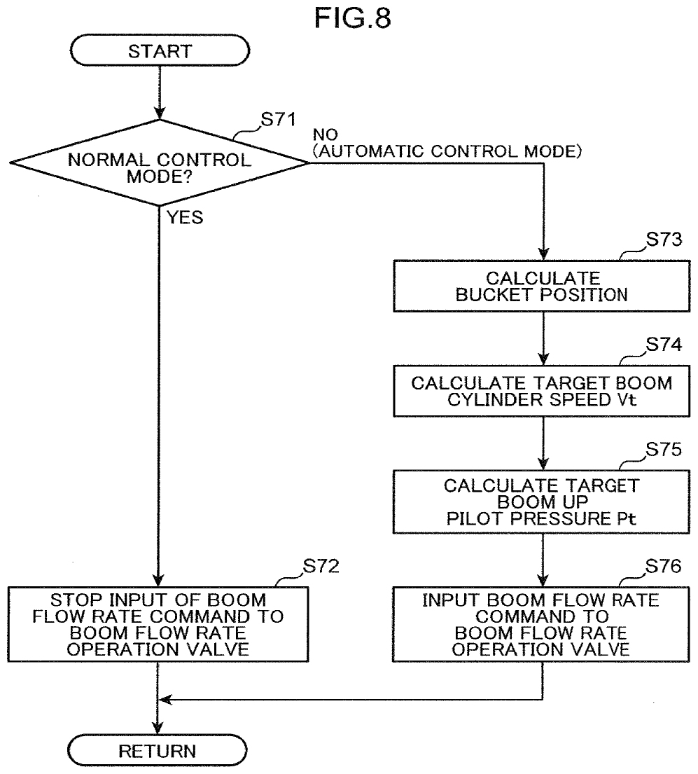

FIG. 8 shows an arithmetic control operation performed by the boom flow rate control device 70.

When the boom flow rate control device 70 is switched to the normal control mode by the operation applied to the mode selector switch 110 (YES in step S71), the boom flow rate command section 107 of the boom flow rate control device 70 stops both the generation of the boom flow rate command and the input of the boom flow rate command to the boom flow rate operation valve 76 (step S72). This causes the generation of the boom-up pilot pressure by the boom flow rate operation valve 76 to be stopped, allowing the secondary pressure of the boom pilot valve 46b of the boom operation device 46 to be always input to the boom-up pilot port 36a of the boom flow rate control valve 36 through the shuttle valve 74 as the boom-up pilot pressure. The boom flow rate control valve 36 is, therefore, operated solely by the boom operation applied to the boom operation device 46 to allow hydraulic fluid to be supplied to the boom cylinder 26 at the boom flow rate corresponding to the boom operation.

On the other hand, when the boom flow rate control device 70 is switched to the automatic control mode (NO in step S71), the boom flow rate command section 107 calculates a boom flow rate command for performing a control of moving the bucket 24 along the target locus along with the operation of the arm cylinder 27 and inputs the boom flow rate command to the boom flow rate operation valve 76 (steps S73 to S76).

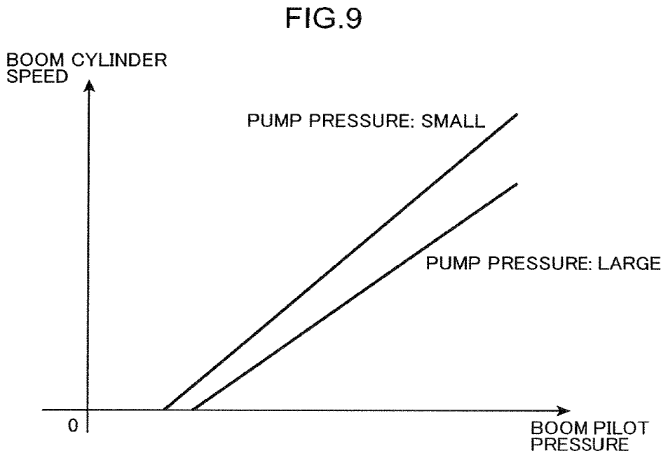

Specifically, the boom flow rate command section 107 performs an operation for generating the boom flow rate command (steps S73 to S75). The boom flow rate command section 107, in step S73, calculates the position of the current bucket 24 based on the posture of the work device 14 detected by the posture detection device 60. The boom flow rate command section 107, in step S74, calculates a target boom cylinder speed Vt for moving the bucket 24 along the target locus with the expansion of the arm cylinder 27, based on the position of the bucket 24 and the speed of the arm cylinder 27 detected by the arm cylinder speed sensor 72. The boom flow rate command section 107, in step S75, calculates the target boom-up pilot pressure Pt for obtaining the above target boom cylinder speed Vt. The target boom-up pilot pressure Pt can be calculated based on the relationship between the boom pilot pressure and the boom cylinder speed, the relationship being determined according to the magnitude of the pump pressure, for example, as shown in FIG. 9.

The boom flow rate command section 107 calculates the boom flow rate command for making the pressure on the secondary side of the boom flow rate operation valve 76 he the target boom up pilot pressure Pt, and inputs this to the boom flow rate operation valve 76 (step S76). Accordingly, when no boom operation is applied to the boom operation device 46, the secondary pressure of the boom flow rate operation valve 76 is input to the boom-up pilot port 36a of the boom flow rate control valve 36 through the shuttle valve 74, thereby allowing the automatic control to be performed for adjusting the boom flow rate so as to allow the bucket 24 to be automatically moved along the target locus simply with the arm operation performed by an operator. However, when such a boom operation as to generate a boom-up pilot pressure exceeding the secondary pressure of the boom flow rate operation valve 76 is applied to the boom operation device 46, a pilot pressure corresponding to the boom operation is input to the boom-up pilot port 36a through the shuttle valve 74. Thus, when an operator applies a large boom operation to the boom operation device 46 during the automatic control, a boom-up pilot pressure for prioritizing the operator's intention is input to the boom flow rate control valve 36.

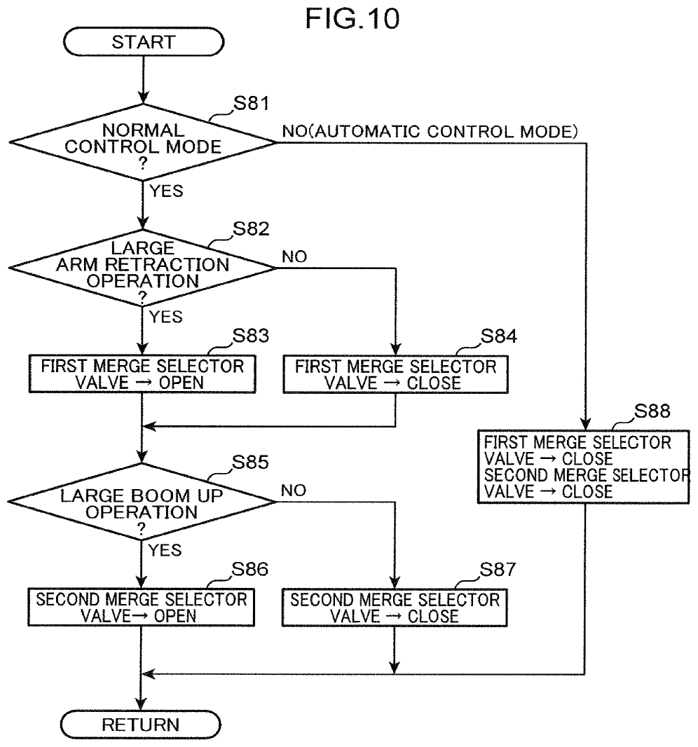

FIG. 10 shows an arithmetic control operation performed by the merge control device 80.

When the boom flow rate control device 70 is switched to the normal control mode (step S81), the merge control device 80 makes the first and second merge selector valves 41 and 42 be opened according to the arm operation and the boom operation, respectively (steps S82 to S87).

Specifically, the merge command section 108 of the merge control device 80, when a certain or larger arm retraction operation (that is, the arm operation for arm retraction motion) is applied to the arm operation device 47 (YES in step S82), inputs the first merge command to the first merge operation valve 81 to shift the first merge selector valve 41 to the merge allowance position, that is, to open the first merge selector valve 41 (step S83). This allows the hydraulic fluid discharged from the first hydraulic pump 31 to be merged with the hydraulic fluid discharged from the second hydraulic pump 32 to be supplied to the head-side chamber 27h of the arm cylinder 27, increasing the speed of the arm retraction motion. On the other hand, when a large arm retraction operation is not applied (including the case where the arm operation for arm pushing motion is applied to the arm operation device 47: NO in step S82), the merge command section 108 stops the input of the first merge command to the first merge operation valve 81 to set the first merge selector valve 41 to the merge check position, that is, to close the first merge selector valve 41 (step S84).

Similarly, when a certain or more large boom-up operation (a boom operation for boom-up motion) is applied to the boom operation device 46 (YES in step S85), the merge command section 108 inputs the second merge command to the second merge operation valve 82 to shift the second merge selector valve 42 to the merge allowance position, that is, to open the second merge operation valve 82 (step S86). This allows the hydraulic fluid discharged from the second hydraulic pump 32 to be merged with the hydraulic fluid discharged from the first hydraulic pump 31 to be supplied to the head-side chamber 26h of the boom cylinder 26, increasing the speed of the boom-up motion. On the other hand, when a large boom-up operation is not applied (including the case where the boom operation for boom-down motion is applied to the boom operation device 46: NO in step S85), the merge command section 108 stops the input of the second merge command to the second merge operation valve 82 to set the second merge selector valve 42 to the merge check position, that is, to close the second merge selector valve 42 (step S87).

When the boom flow rate control device 70 is switched to the automatic control mode (NO in step S81), the merge command section 108 shifts both the first and second merge selector valves 41 and 42 to their respective merge check positions, that is, closes the first and second merge selector valves 41 and 42 regardless of the arm operation and the boom operation (step S88). This renders the boom drive circuit for supplying hydraulic fluid from the first hydraulic pump 31 to the boom cylinder 26 and the arm drive circuit for supplying hydraulic fluid from the second hydraulic pump 32 to the arm cylinder 27 mutually independent, thereby preventing the boom flow rate and the arm flow rate from mutual interference to allow the accuracy of the automatic control to be prevented from being decreased by the mutual interference.

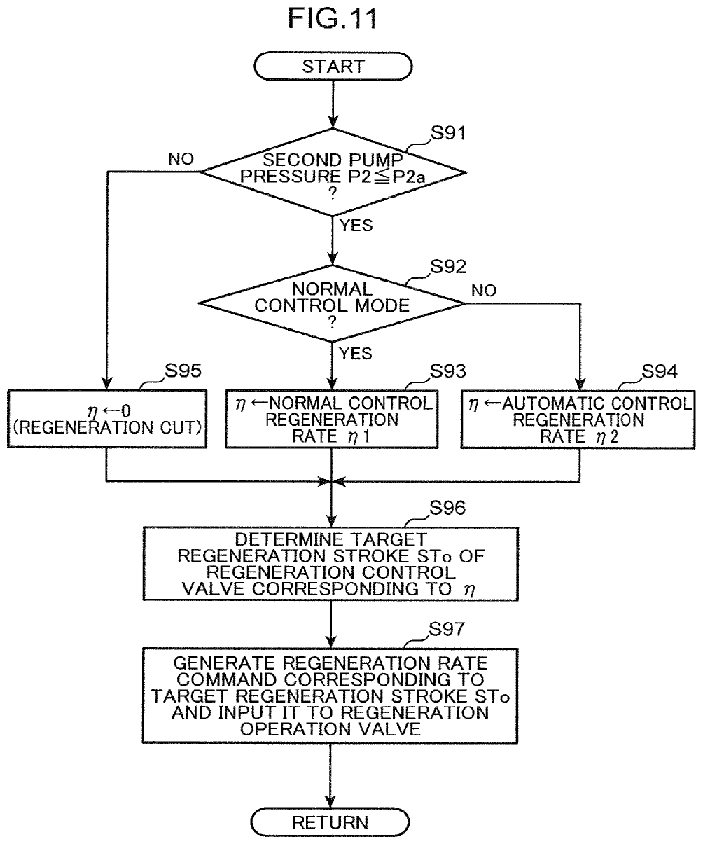

FIG. 11 shows an arithmetic control operation performed by the regeneration control device 90. The regeneration control device 90 according to this embodiment performs regeneration control by use of a second pump pressure P2 which can be regarded as substantially equivalent to the arm head pressure (although the value of the arm rod pressure itself may be used).

Specifically, in a low load situation where the second pump pressure P2 is equal to or less than a preset allowable pressure P2a (YES in step S91), the regeneration control device 90 performs setting of the regeneration rate η at the regeneration control valve 43 corresponding to the control mode of the boom flow rate control device 70 (steps S92 to S94). Specifically, when the boom flow rate control device 70 is switched to the normal control mode (YES in step S92), the regeneration command section 109 of the regeneration control device 90 sets the regeneration rate n to a predetermined normal control regeneration rate η1 (step S93), whereas, when the boom flow rate control device 70 is switched to the automatic control mode, the regeneration command section 109 sets the regeneration rate η to an automatic control regeneration rate η2 which is lower than the normal control regeneration rate η1 (η2<η1) (step S94).

In the high load situation where the second pump pressure P2 is larger than the allowable pressure P2a to make the regeneration operation (direct introduction of hydraulic fluid from the rod-side chamber 27r to the head-side chamber 27h) impossible (NO in step S91), the regeneration command section 109 sets the regeneration rate η to 0 (step S95). In short, it performs setting of the regeneration rate for shifting the regeneration control valve 43 to the regeneration cut position Pc.

The regeneration command section 109 determines the target regeneration stroke STo of the regeneration control valve 43 corresponding to the regeneration rate n that is set as described above (step S96), generating a regeneration rate command signal for obtaining the target regeneration stroke STo and inputting the regeneration rate command signal to the regeneration operation valve 93 (step S97).

As described above, the automatic control regeneration rate η2 which is a regeneration rate when the boom flow rate control device 70 is switched to the automatic control mode in the low load situation is set to be smaller than the normal control regeneration rate η1 which is a regeneration rate when the boom flow rate control device 70 is switched to the normal control mode in the low load situation; this restrains the arm flow rate from being sharply decreased by a sharp increase in the workload due to a sharp increase in the excavation resistance against the bucket 24 or the like, thereby enabling the accuracy of the automatic control to be kept high. The reason is as follows.

When the second pump pressure P2 corresponding to the arm head pressure is sharply increased by the above-described sharp increase in the workload, the regeneration command section 109 of the regeneration control device 90 inputs a regeneration rate command (regeneration cut command) to the regeneration operation valve 93 for switching the regeneration control valve 43 from the previous regeneration position Pr to the regeneration cut position Pc; however, there is a response delay from the time when such regeneration rate command is input to the regeneration operation valve 93 until the regeneration control valve 43 is actually switched to the regeneration cut position Pc. If the regeneration rate η at the regeneration control valve 43 upon the sharp increase in the workload (in the low load situation) is large (for example, if the regeneration rate η is the normal control regeneration rate η1), for example, when the meter-out throttle opening Ao is significantly restricted relatively to the regeneration throttle opening Ar in the regeneration stroke ST1 shown in FIG. 4, the discharge of hydraulic fluid from the rod-side chamber 27r of the arm cylinder 27 to the tank is kept remarkably restricted until the regeneration control valve 43 is actually switched to the regeneration cut position Pc in response to the sharp increase in the workload. This generates a possibility of a significant increase in the arm head due to the sharp increase in the workload. Besides, the pump control device 50 performing the horsepower control reduces the capacity of the second hydraulic pump 32 with the increase in the average pump pressure Pa corresponding to the arm head pressure, for example, from the pressure Pao shown in FIG. 7 to the pressure Pa1, to thereby greatly lower the pump flow rate of the second hydraulic pump 32 from the previous flow rate (in FIG. 7, the maximum pump flow rate Qmax) to the flow rate Q1 (the path R1 in FIG. 7). This involves a sharp decrease in the arm flow rate and the arm cylinder speed corresponding thereto, having possibility of hindering the control of the boom flow rate to move the bucket 24 along the target locus from being performed with high accuracy.

In contrast, restricting the regeneration rate for the automatic control mode to make the regeneration stroke ST of the regeneration control valve 43 be, for example, ST2 as shown in FIG. 4, allows a meter-out throttle opening Ao to he secured for letting discharge hydraulic fluid from the rod-side chamber 27r escape during the response delay, thereby allowing the arm head pressure to be restrained from sharp increase caused by the response delay. For example, the restriction of the regeneration rate η in the low load situation enables the increase in the average pump pressure Pa from the pressure Pao shown in FIG. 7 to be restricted not to the pressure Pa1 but to a lower pressure Pa2 than the pressure Pa1. This makes it possible to restrict the decrease in the pump flow rate to a flow rate Q2 that is higher than the flow rate Q1 (the path R2 in FIG. 7). Thus restricting a sharp decrease in the arm flow rate allows the automatic control to be performed with high accuracy regardless of the execution of the regeneration control.

On the other hand, in the normal control mode not requiring high accuracy of the adjustment of the high boom flow rate as described above, the regeneration rate η of the regeneration control valve 43 can be set to be high to allow the arm retraction motion to be performed at a high speed.

The present invention is not limited to the embodiments described above. The present invention may encompass, for example, the following aspects.

(1) Regeneration Rate

Although the constant regeneration rates η1 and η2, in the above-described embodiment, are set for the normal control mode and the automatic control mode, respectively, the present invention also encompasses, for example, another embodiment in which the regeneration rate is adjusted to a smaller value with the increase in the arm head pressure. Also in this embodiment, differentiating the regeneration rate corresponding to the same arm head pressure between the normal control mode and the automatic control mode allows the same effect as described above to be obtained.

(2) Location of Regeneration Control Valve

Although the regeneration control valve 43 shown in FIG. 2 is provided in the merge circuit between the first merge selector valve 41 and the arm cylinder 27, the present invention also encompasses another embodiment in which the regeneration control valve is provided in a dedicated regeneration circuit other than the merge circuit. However, the arrangement as shown in FIG. 2 enables the merge circuit to be utilized as the regeneration circuit, thereby allowing the regeneration operation to be realized with a simple configuration.

(3) Number of Hydraulic Pumps

The present invention also encompasses another embodiment in which the hydraulic fluid supply device includes only a single hydraulic pump from which hydraulic fluid is supplied to each of the boom cylinder and arm cylinder, that is, an embodiment including no merge circuit. Also in such an embodiment, changing the regeneration rate depending on the control mode of the boom flow rate control device allows the same effect as described above to be obtained.

(4) Boom Operation Device and Arm Operation Device

The boom operation device and the arm operation device according to the present invention are not limited to those including the pilot valves 46b and 47b as described above, also permitted to be, for example, electric lever devices that output respective electric signals corresponding to the boom operation and the arm operation. In this case, the boom flow rate control device, by inputting the boom flow rate command to the solenoid proportional pressure reducing valve or the like (corresponding to the boom flow rate operation valve 76) so that the boom-up pilot pressure corresponding to the boom operation in the normal control mode is input to the boom flow rate control valve, can allow the boom flow rate control valve and the boom cylinder to operate in response to the boom operation.

(5) Pump Control Device

The pump control device according to the present invention is not limited to the above positive control as long as it performs at least horsepower control. The pump control device may perform, for example, the horsepower control and a negative control.

As described above, according to the present invention, there is provided a hydraulic drive apparatus provided in a work machine equipped with a work device including a boom, an arm, and a work attachment to hydraulically actuate the work device, the hydraulic drive apparatus being capable of performing both an automatic control of synchronizing respective movements of the boom and the arm so as to make the work attachment moved along a predetermined target locus and a regeneration operation of regenerating return fluid from an arm cylinder for actuating the arm, and further capable of performing the automatic control with high accuracy regardless of the execution of the regeneration operation.

Provided is a hydraulic drive apparatus provided in a work machine equipped with a machine body and a work device, the work device including a boom supported by the machine body so as to be raiseable and lowerable, an arm connected to a distal end of the boom rotationally movably, and a work attachment attached to a distal end of the arm, to hydraulically drive the boom and the arm, the hydraulic drive apparatus including: a hydraulic fluid supply device including at least one variable displacement type hydraulic pump that is driven by a drive source to thereby discharge hydraulic fluid; a boom cylinder that is expanded and contracted by supply of the hydraulic fluid from the hydraulic fluid supply device to raise and lower the boom; an arm cylinder that is expanded and contracted by supply of hydraulic fluid from the hydraulic fluid supply device to rotationally actuate the arm, the arm cylinder having a head-side chamber and a rod-side chamber opposite to the head-side chamber, the arm cylinder connected to the arm so as to be expanded by supply of the hydraulic fluid to the head-side chamber to actuate the arm in a retraction direction and so as to be contracted by supply of the hydraulic fluid to the rod-side chamber to actuate the arm in a push direction; a pilot-operated boom flow rate control valve interposed between the hydraulic fluid supply device and the boom cylinder and being capable of being opened and closed so as to change a boom flow rate, which is a flow rate of hydraulic fluid supplied from the hydraulic fluid supply device to the boom cylinder; a pilot-operated arm flow rate control valve interposed between the hydraulic fluid supply device and the arm cylinder and being capable of being opened and closed so as to change an arm flow rate, which is a flow rate of hydraulic fluid supplied from the hydraulic fluid supply device to the arm cylinder; a regeneration control valve having a regeneration position for forming a regeneration flow path that allows a discharge hydraulic fluid that is discharged from the rod-side chamber to return to the head-side chamber when the arm cylinder is expanded and a meter-out flow path that allows the discharge hydraulic fluid to return to a tank, and a regeneration cut position for blocking the regeneration flow path and maximizing an opening area of the meter-out flow path, the regeneration control valve being capable of being opened and closed so as to change a regeneration rate, which is a ratio of a regeneration flow rate to a total return flow rate that is a total sum of the regeneration flow rate and a meter-out flow rate, the regeneration flow rate and the meter-out flow rate being respective flow rates of the hydraulic fluids flowing through the regeneration flow path and the meter-out flow path, respectively; a boom operation device to which a boom operation for moving the boom is applied, an arm operation device to which an arm operation for moving the arm is applied; a pump control device that executes a horsepower control of adjusting a capacity of the at least one hydraulic pump so as to keep a total horsepower of the at least one hydraulic pump included in the hydraulic fluid supply device within an allowable horsepower that is set for the drive source; a posture detection device that detects a posture of the work device for determining a position of the work attachment; a boom flow rate control device that is switchable between a normal control mode and an automatic control mode, the boom flow rate control device configured to allow, in the normal control mode, the boom flow rate control valve and the arm flow rate control valve to operate so as to change the boom flow rate and the arm flow rate in response to the boom operation and the arm operation applied to the boom operation device and the arm operation device, respectively, and configured to adjust, in the automatic control mode, the boom flow rate based on the posture detected by the posture detection device so as to make the work attachment moved along a preset target locus; and a regeneration control device configured to set the regeneration control valve to the regeneration position in a low load situation where an arm head pressure, which is a pressure of the hydraulic fluid supplied to the head-side chamber of the arm cylinder, is equal to or less than a preset allowable pressure and configured to set the regeneration control valve to the regeneration cut position in a high load situation where the arm head pressure is higher than the allowable pressure. The regeneration control device operates the regeneration control valve so as to make the regeneration rate in the low load situation lower when the boom flow rate control device is switched to the automatic control mode than that when the boom flow rate control device is switched to the normal control mode.

According to this apparatus, it is possible to restrain the arm flow rate from being sharply decreased by a sharp increase in the workload in the automatic control mode to keep the accuracy of the automatic control high while increasing the speed of the arm cylinder by regeneration of the return hydraulic fluid from the arm cylinder.

Specifically, in the normal control mode for allowing the boom flow rate and the arm flow rate to be changed in accordance with the boom operation and the arm operation and not requiring a control accuracy, the regeneration control device can set a relatively high regeneration in the low load situation where the arm head pressure is equal to or less than the allowable value to thereby enables the speed of the arm cylinder in the low load situation to be effectively increased. In contrast, in the automatic control mode requiring adjustment of the boom flow rate so as to move the work attachment along the target locus, setting a relatively low regeneration rate in the low load situation where the arm head pressure is equal to or less than the allowable value suppresses the width of increase in the boom pressure from sharp increase in the workload until the regeneration control valve is switched to the regeneration cut position to thereby restrict a decrease in the arm flow rate caused by the increase in the boom pressure.

More specifically, when the sharp increase in the workload as described above occurs to make the arm head pressure exceed the allowable value, the regeneration control device operates the regeneration control valve to switch it from the regeneration position to the regeneration cut position (that is, the position for blocking the regeneration flow path and maximizing the opening area of the meter-out flow path); however, there is a response delay from the sharp increase in workload as described above until the regeneration control valve is actually switched to the regeneration cut position. In the case of large regeneration rate at the regeneration control valve in the low load situation, that is, in the case of small ratio of the meter-out flow rate to the regeneration flow rate, the regeneration control valve significantly restricts the discharge of hydraulic fluid from the rod-side chamber of the arm cylinder while keeping the opening area of the meter-out flow path small until the regeneration control valve is actually switched to the regeneration cut position in response to the sharp increase in the workload; this causes the arm head pressure which is the pressure in the rod-side chamber of the arm cylinder to be significantly increased due to the sharp increase in the workload. Moreover, the pump control apparatus performing the horsepower control reduces the capacity of the hydraulic pump with an increase in the pump pressure that is the discharge pressure of the hydraulic pump corresponding to the arm head pressure, resulting in a sharp decrease in the arm flow rate. This hinders the automatic control of adjusting the boom flow rate so that the work attachment moves along the target locus from being performed with high accuracy.

In contrast, the regeneration control device according to the present invention, which restricts the regeneration rate of the regeneration control valve in the low load situation, when the boom flow rate control device is switched to the automatic control mode, to keep the opening area of the meter-out flow path in the regeneration control valve larger than that in the normal control mode, can restrain the arm head pressure from being sharply increased in the period of the response delay from the sharp increase in the workload until the regeneration control valve is actually switched to the regeneration cut position. This restrains the arm flow rate from being sharply decreased by lowering the capacity of the at least one hydraulic pump by the pump flow rate control device in response to the sharp increase in the discharge pressure of the hydraulic pump that corresponds to the arm head pressure, thereby allowing the automatic control to be performed with high accuracy.

Although the at least one hydraulic pump constituting the hydraulic fluid supply device in the present invention may be only a single hydraulic pump (that is, hydraulic fluid may be supplied from a single hydraulic pump to both the boom cylinder and the arm cylinder), it is preferable that: the at least one hydraulic pump includes a first hydraulic pump and a second hydraulic pump; the boom flow rate control valve is interposed between the first hydraulic pump and the boom cylinder to change the flow rate of hydraulic fluid supplied from the first hydraulic pump to the boom cylinder; the arm flow rate control valve is interposed between the second hydraulic pump and the arm cylinder to change the flow rate of hydraulic fluid supplied from the second hydraulic pump to the arm cylinder; and the hydraulic drive apparatus further includes: a first merge selector valve switchable between a merge allowance position for allowing a part of the hydraulic fluid discharged from the first hydraulic pump to be merged with the hydraulic fluid discharged from the second hydraulic pump to be supplied to the arm cylinder and a merge check position for checking the merge; a second merge selector valve switchable between a merge allowance position for allowing a part of the hydraulic fluid discharged from the second hydraulic pump to be merged with the hydraulic fluid discharged from the first hydraulic pump to be supplied to the boom cylinder and a merge check position for checking the merge; and a merge control device configured to set the first merge selector valve to the merge allowance position in accordance with the arm operation and to set the second merge selector valve to the merge allowance position in accordance with the boom operation when the boom flow rate control device is switched to the normal control mode and configured to set each of the first merge selector valve and the second merge selector valve to the merge check position regardless of the boom operation and the arm operation when the boom flow rate control device is switched to the automatic control mode.

The merge control device according to this embodiment switches, when the boom flow rate control device is switched to the normal control mode, each of the first and second merge selector valves to the merge allowance position in accordance with the arm retraction operation and the boom-up operation to thereby allow respective speeds of the arm cylinder and the boom cylinder to be increased in response to the requirement by an operator. On the other hand, when the boom flow rate control device is switched to the automatic control mode, the merge control device forcibly switches each of the first and second merge selector valves to the merge check position to render the boom drive circuit from the first hydraulic pump to the boom cylinder and the arm drive circuit from the second hydraulic pump to the arm cylinder mutually independent, thereby preventing the boom flow rate and the arm flow rate from mutual interference to enable the automatic control to be performed with higher accuracy.

In this aspect, the regeneration control valve is preferably provided between the

W7566 first merge selector valve and the arm cylinder and configured to form a flow path for allowing a merge hydraulic fluid to be supplied from the first merge selector valve to the head-side chamber of the arm cylinder in the regeneration position and the regeneration cut position. This enables the regeneration of the return fluid from the arm cylinder to be performed with a simple configuration utilizing the merge circuit from the first merge selector valve to the arm cylinder as the regeneration circuit.

1. A hydraulic drive apparatus provided in a work machine equipped with a machine body and a work device, the work device including a boom supported by the machine body so as to be raiseable and lowerable, an arm connected to a distal end of the boom rotationally movably, and a work attachment attached to a distal end of the arm, to hydraulically drive the boom and the arm, the hydraulic drive apparatus comprising:
a hydraulic fluid supply device including at least one variable displacement type hydraulic pump that is driven by a drive source to thereby discharge hydraulic fluid;
a boom cylinder that is expanded and contracted by supply of the hydraulic fluid from the hydraulic fluid supply device to raise and lower the boom;
an arm cylinder that is expanded and contracted by supply of hydraulic fluid from the hydraulic fluid supply device to rotationally actuate the arm, the arm cylinder having a head-side chamber and a rod-side chamber opposite to the head-side chamber, the arm cylinder connected to the arm so as to be expanded by supply of the hydraulic fluid to the head-side chamber to actuate the arm in a retraction direction and so as to be contracted by supply of the hydraulic fluid to the rod-side chamber to actuate the arm in a push direction;
a pilot-operated boom flow rate control valve interposed between the hydraulic fluid supply device and the boom cylinder and being capable of being opened and closed so as to change a boom flow rate, which is a flow rate of hydraulic fluid supplied from the hydraulic fluid supply device to the boom cylinder;
a pilot-operated arm flow rate control valve interposed between the hydraulic fluid supply device and the arm cylinder and being capable of being opened and closed so as to change an arm flow rate, which is a flow rate of hydraulic fluid supplied from the hydraulic fluid supply device to the arm cylinder;
a regeneration control valve having a regeneration position for forming a regeneration flow path that allows a discharge hydraulic fluid that is discharged from the rod-side chamber to return to the head-side chamber when the arm cylinder is expanded and a meter-out flow path that allows the discharge hydraulic fluid to return to a tank, and a regeneration cut position for blocking the regeneration flow path and maximizing an opening area of the meter-out flow path, the regeneration control valve being capable of being opened and closed so as to change a regeneration rate, which is a ratio of a regeneration flow rate to a total return flow rate that is a total sum of the regeneration flow rate and a meter-out flow rate, the regeneration flow rate and the meter-out flow rate being respective flow rates of the hydraulic fluids flowing through the regeneration flow path and the meter-out flow path, respectively;
a boom operation device to which a boom operation for moving the boom is applied,
an arm operation device to which an arm operation for moving the arm is applied;
a pump control device that executes a horsepower control of adjusting a capacity of the at least one hydraulic pump so as to keep a total horsepower of the at least one hydraulic pump included in the hydraulic fluid supply device within an allowable horsepower that is set for the drive source;
a posture detection device that detects a posture of the work device for determining a position of the work attachment;
a boom flow rate control device that is switchable between a normal control mode and an automatic control mode, the boom flow rate control device configured to allow, in the normal control mode, the boom flow rate control valve and the arm flow rate control valve to operate so as to change the boom flow rate and the arm flow rate in response to the boom operation and the arm operation applied to the boom operation device and the arm operation device, respectively, and configured to adjust, in the automatic control mode, the boom flow rate based on the posture detected by the posture detection device so as to make the work attachment moved along a preset target locus; and
a regeneration control device configured to set the regeneration control valve to the regeneration position in a low load situation where an arm head pressure, which is a pressure of the hydraulic fluid supplied to the head-side chamber of the arm cylinder, is equal to or less than a preset allowable pressure and configured to set the regeneration control valve to the regeneration cut position in a high load situation where the arm head pressure is higher than the allowable pressure, the regeneration control device configured to operate the regeneration control valve so as to make the regeneration rate in the low load situation lower when the boom flow rate control device is switched to the automatic control mode than that when the boom flow rate control device is switched to the normal control mode.

2. The hydraulic drive apparatus for the work machine according to claim 1, wherein:
the at least one hydraulic pump includes a first hydraulic pump and a second hydraulic pump; the boom flow rate control valve is interposed between the first hydraulic pump and the boom cylinder to change the flow rate of the hydraulic fluid supplied from the first hydraulic pump to the boom cylinder; and the arm flow rate control valve is interposed between the second hydraulic pump and the arm cylinder to change the flow rate of the hydraulic fluid supplied from the second hydraulic pump to the arm cylinder, the hydraulic drive apparatus further comprising: a first merge selector valve switchable between a merge allowance position for allowing a part of the hydraulic fluid discharged from the first hydraulic pump to be merged with the hydraulic fluid discharged from the second hydraulic pump to be supplied to the arm cylinder and a merge check position for checking the merge; a second merge selector valve switchable between a merge allowance position for allowing a part of the hydraulic fluid discharged from the second hydraulic pump to be merged with the hydraulic fluid discharged from the first hydraulic pump to be supplied to the boom cylinder and a merge check position for checking the merge; and
a merge control device configured to set the first merge selector valve to the merge allowance position in accordance with the arm operation and to set the second merge selector valve to the merge allowance position in accordance with the boom operation when the boom flow rate control device is switched to the normal control mode and configured to set each of the first merge selector valve and the second merge selector valve to the merge check position regardless of the boom operation and the arm operation when the boom flow rate control device is switched to the automatic control mode.

3. The hydraulic drive apparatus of the work machine according to claim 2, wherein the regeneration control valve is provided between the first merge selector valve and the arm cylinder, and configured to form a flow path allowing a merge hydraulic fluid to be supplied from the first merge selector valve to the head-side chamber of the arm cylinder in each of the regeneration position and the regeneration cut position.
